(19) United States
(12) Patent Application Publication
(10) Pub. No.: US 2018/0249857 A1
(43) Pub. Date: Sep. 6, 2018

(54) DRIPPER AND FILTER SET

(71) Applicant: Tsung-Yu Weng, New Taipei City (TW)

(72) Inventor: Tsung-Yu Weng, New Taipei City (TW)

(21) Appl. No.: 15/847,831

(22) Filed: Dec. 19, 2017

(30) Foreign Application Priority Data
Mar. 2, 2017 (TW) 106202892

(51) Int. Cl. A47J 31/02; A47J 31/06; B01D 39/12

(52) U.S. Cl. CPC A47J 31/02; B01D 39/12; A47J 31/06

(57) ABSTRACT

A dripper and filter set includes a dripper, and a filter device detachably mounted in the dripper and including an inner positioning ring, a wire mesh filter mounted on the inner positioning ring and an outer positioning ring attached onto the wire mesh filter and the inner positioning ring to secure the wire mesh filter in position. Thus, the dripper and filter set facilitates cleaning, and the application of the dripper and filter set for brewing coffee or tear does not need to use a paper filter.

### BACKGROUND OF THE INVENTION

### 1. Field of the Invention

The present invention relates to beverage brewing technology and more particularly, to a dripper and filter set, which eliminates the use of a paper filter, facilitates cleaning and is good for human health.

### 2. Description of the Related Art

When brewing coffee or tea by hand, it is to put coffee powder or tea leaves in a dripper and then to pour boiling water through the coffee powder or over the tea leaves in the dripper. To make a satisfactory cup of coffee or tea, some brewing steps and procedures are necessary. For example, using a small mouth pot that can effectively control the size and stability of the water column. During the brewing process, it is necessary to make a circle action to prevent a broken water column. Further, the brewing time also affects the drinking quality of coffee or tea. If the brewing time is too short, the taste of coffee or tea is not enough, however, if the brewing time is too long, there will be a bitter taste

FIG. 1 illustrates a coffee brewing hand set 10 for brewing coffee or tea. The coffee brewing hand set 10 comprises a beverage container 11, and a dripper 12 for positioning on the top side of the beverage container 11. The dripper 12 is shaped like a hollow funnel, having a flattened bottom 13 for positioning on the top side of the beverage container 11. When using the coffee brewing hand set 10 to brew coffee or tea, put a paper filter 14 in the dripper 12, and then put prepared coffee powder or tea bag 15 in the paper filter 14, and then use a mall mouth pot 16 to pour boiling water into the dripper 12, enabling brewed coffee or tea to flow into the beverage container 11. Brewing coffee or tea in this manner needs to use a paper filter 14. This manner is not only wasteful but also not environmentally friendly. Such paper filter 14 usually contains chemical components or is made by a bleaching procedure, which is likely to cause harm to human health.

To brew a satisfactory cup of coffee beverage, for example, basically roasted coffee beans must be stored in a damp-proof box for about 20 days. Before brewing, the coffee beans must be ground to a specific fine grain. When starting to brew coffee, it is necessary to pour boiling water of a specific temperature into the dripper using the above small mouth pot 16 at different heights and orientations.

FIGS. 2 and 2a illustrates another design of filter cup 20 for brewing coffee or tea. The filter cup 20 comprises an upper cup ring 21, a lower cup ring 22 with a bottom outlet 24, and a funnel-shaped wire mesh filter 23 set between the upper cup ring 21 and the lower cup ring 22. In order to form the proper filtration time, as illustrated in FIG. 2A, the funnel-shaped wire mesh filter 23 is configured to provide an inner layer 231 and an outer layer 232. After a long use of this double-layer design of wire mesh filter 23, grease will be generated in between the inner layer 231 and an outer layer 232, making the brewed beverage contain oily odor. Cleaning the intercalating grease between the inner layer 231 and the outer layer 232 needs to use citric acid or baking soda that will adversely affect human health.

### SUMMARY OF THE INVENTION

The present invention has been accomplished under the circumstances in view. It is one object of the present invention to provide a dripper and filter set, which eliminates the use of a paper filter, preventing damage to the human body and achieving the purpose of being more environmentally friendly.

It is another object of the present invention to provide a dripper and filter set, which is practical for repeated use and facilitates cleaning.

It is still another object of the present invention to provide a dripper and filter set, which allows control of brewing and filtering speed and time.

To achieve these and other objects of the present invention, a dripper and filter set comprises a dripper and a filter device. The dripper comprises a top opening, a bottom wall, and at least one water outlet cut through the bottom wall. The filter device fits the configuration of the bottom wall and is positioned on the bottom wall within the dripper, comprising a wire mesh filter, an inner positioning ring and an outer positioning ring that is greater than the inner positioning ring in size. The wire mesh filter comprises a filter surface, and a skirt portion extended around the filter surface. The wire mesh filter is attached onto the inner positioning ring with the filter surface supported on the top side of the inner positioning ring to create a filter layer and the skirt portion surrounding the periphery of the inner positioning ring. The outer positioning ring is attached onto the inner positioning ring and the wire mesh filter for enabling the skirt portion to be squeezed in between the inner positioning ring and the outer positioning ring.

Further, the inner positioning ring and the outer positioning ring each comprise a plurality of water holes cut through opposing inner perimeter and outer perimeter thereof.

Further, the apertures of the water holes are configured subject to a predetermined brewing speed.

Other advantages and features of the present invention will be fully understood by reference to the following specification in junction with the accompanying drawings, in which like reference signs denote like components of structure.

### BRIEF DESCRIPTION OF THE DRAWINGS

FIG. 1 is a schematic drawing of a coffee brewing hand set according to the prior art.

FIG. 2 is a schematic side view of a coffee dripper according to the prior art.

FIG. 2A is an enlarged view of Part A of FIG. 2.

FIG. 3 is an oblique top elevational view of a dripper and filter set in accordance with the present invention.

FIG. 4 is an exploded view of the dripper and filter set in accordance with the present invention.

FIG. 5 is a schematic drawing illustrating the mounting arrangement and structure of the filter device of the dripper and filter set in accordance with the present invention.

FIG. 5A is an enlarged view of Part B of FIG. 5.

FIG. 6 is a sectional view of the filter device of the dripper and filter set in accordance with the present invention.

FIG. 7 is a schematic applied view illustrating a brewing operation of the dripper and filter set in accordance with the present invention.

### DETAILED DESCRIPTION OF THE PREFERRED EMBODIMENT

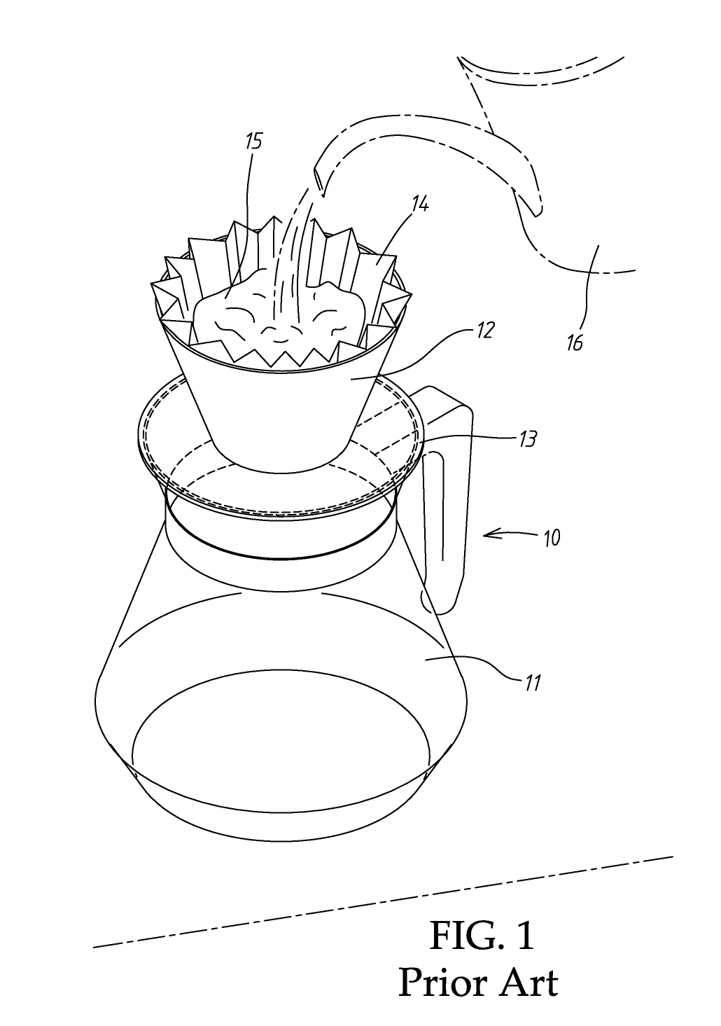

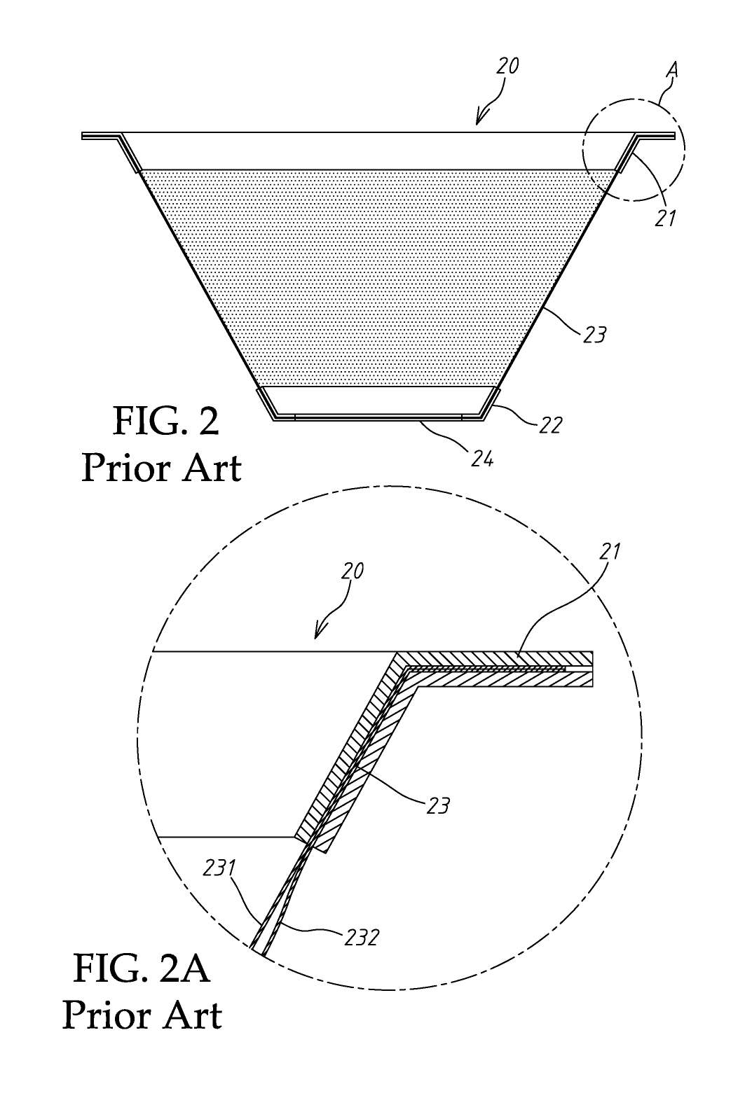

Referring to FIGS. 1-5, a dripper and filter set 30 in accordance with the present invention is shown. The dripper and filter set comprises a dripper 31 and a filter device 50. The dripper 31 comprises a top opening 32, a bottom wall 33, at least one water outlet 35 cut through the bottom wall 33, at least one water channel 34 raised from a top surface of the bottom wall 33 and respective from the center of the top surface of the bottom wall 33 to the at least one water outlet 35. The filter device 50 is positively supported on the bottom wall 33 above the water channel 34 and water outlet 35 within the dripper 31. In this embodiment, the dripper 31 further comprises a flange 36 extended around the bottom wall 33 and formed integral with the bottom wall 33 to create a flattened bottom for positioning on the topmost edge of a drinking container.

The filter device 50 comprises a wire mesh filter 51, an inner positioning ring 52 and an outer positioning ring 53. The wire mesh filter 51 is set to a specific size, comprising a filter surface 54 and a skirt portion 55 extended around the filter surface 54. In this embodiment, the inner positioning ring 52 and the outer positioning ring 53 have different diameters, each comprising a plurality of water holes 56;57 cut through opposing inner and outer perimeters thereof. Further, the inner diameter of the outer positioning ring 53 is larger than the outer diameter of the inner positioning ring 52.

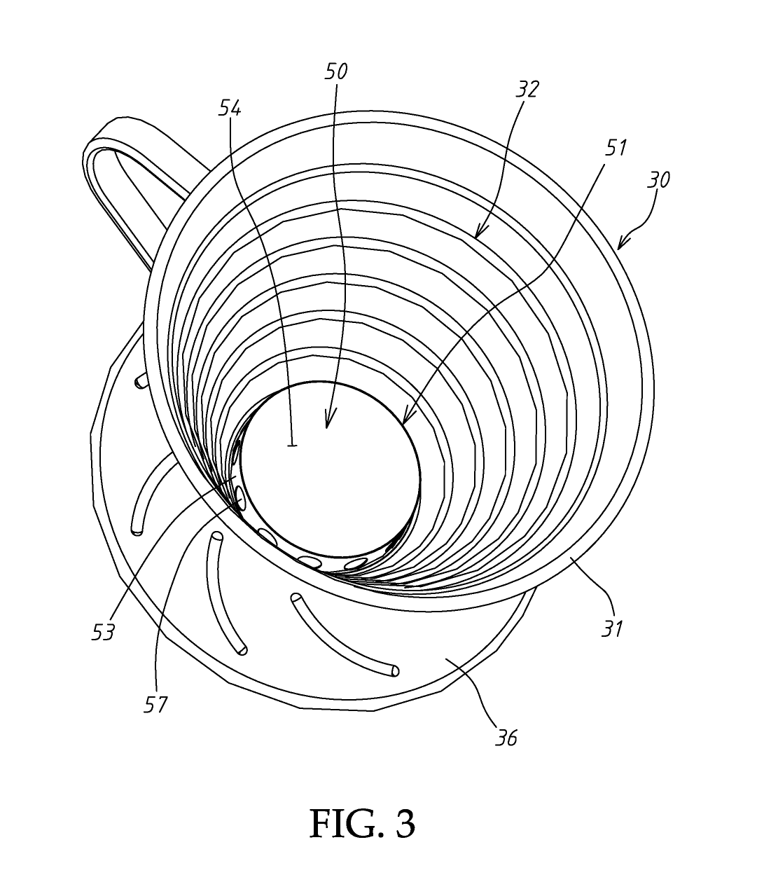

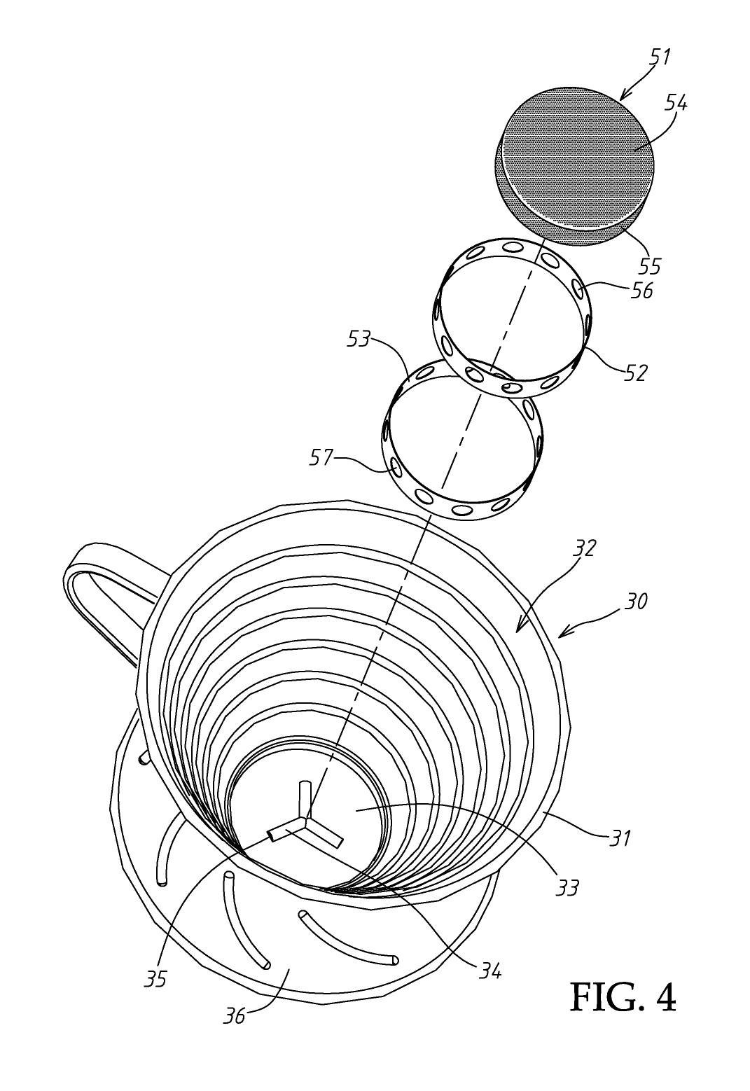

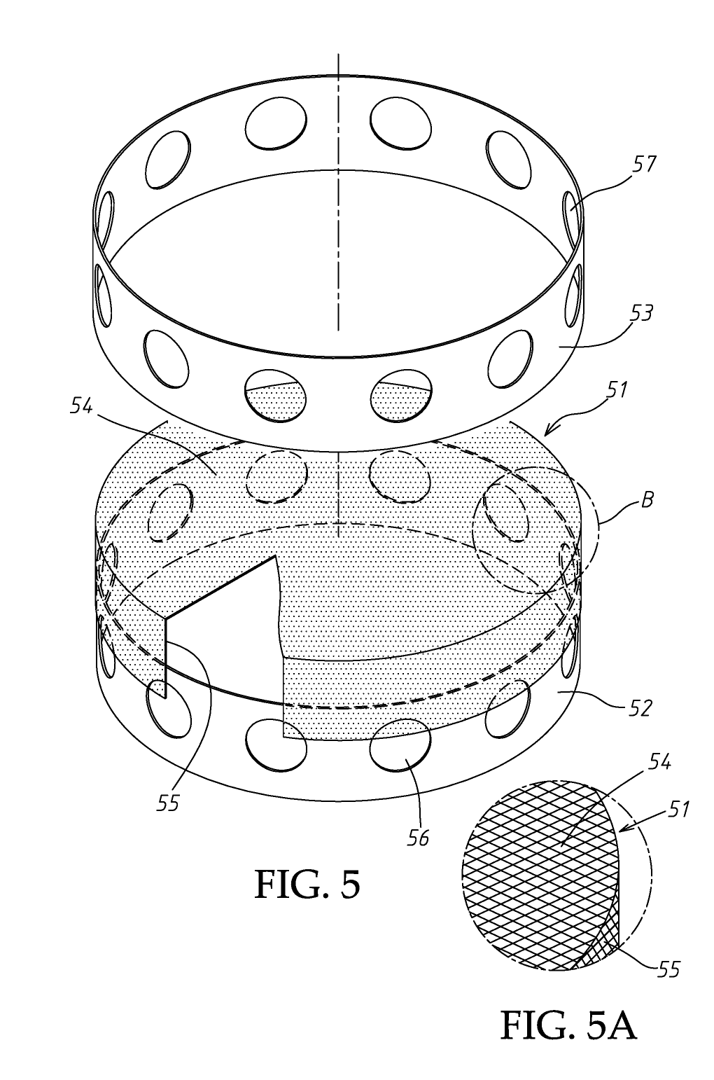

Referring to FIGS. 4-6, the wire mesh filter 51 is attached onto the inner positioning ring 52 with the filter surface 54 supported on the inner positioning ring 52 to create a filter layer and the skirt portion 55 surrounding the periphery of the inner positioning ring 52 (see FIG. 5), and then the outer positioning ring 53 is attached onto the wire mesh filter 51 and the inner positioning ring 52 with the skirt portion 55 squeezed in between the inner positioning ring 52 and the outer positioning ring 53 (see FIG. 3).

In a feasible embodiment, the wire mesh filter 51 may be made of stainless steel or the like, but this is only for convenience of illustration and not for limitation. Other materials that do not generate harmful substances during the brewing process can be used for making the wire mesh filter 51.

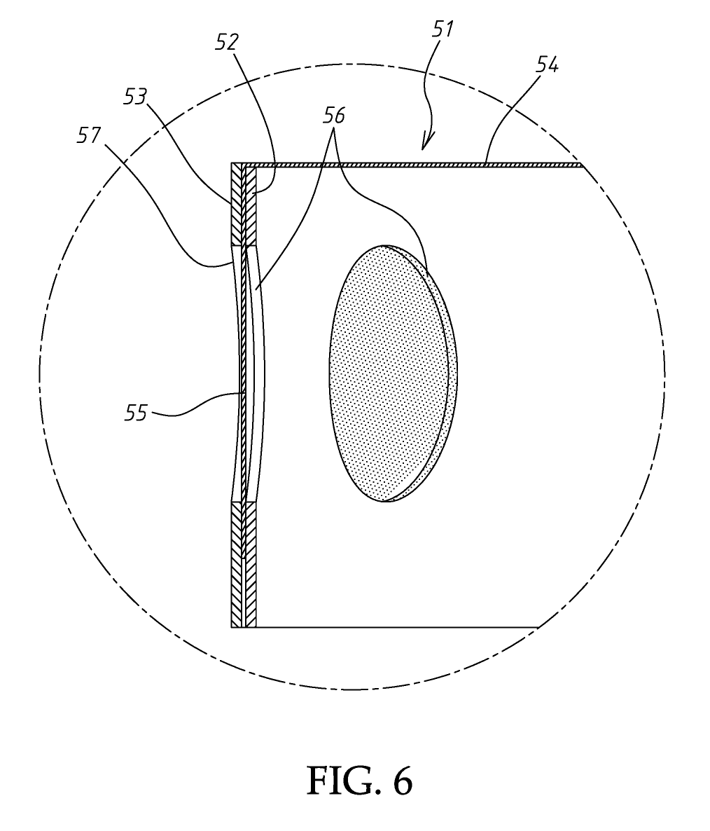

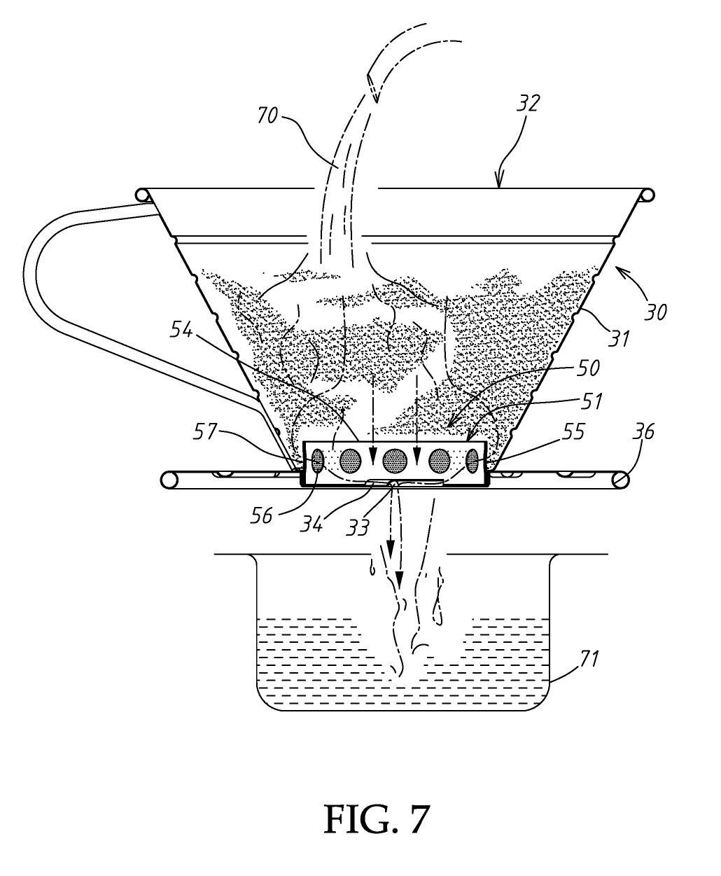

As illustrated in FIGS. 6 and 7, when brewing coffee or tea, the applied fluid 70 flows over tea leaves or through coffee powder, and then flows through the filter surface 54 of the wire mesh filter 51, the water holes 57 of the outer positioning ring 53, the skirt portion 55 and the water holes 56 of the inner positioning ring 52 to drip into the drinking container 71 via the water outlets 35 at the ends of the water channel 34. In the above brewing process, the filter surface 54 of the wire mesh filter 51 filters solid matters from the applied fluid 70, the water holes 56;57 of the inner and outer positioning rings 52;53 control the brewing and filtering speed and time.

Using the dripper and filter set 30 of the present invention to brew coffee or tear does not need to use a paper filter, therefore, the use of the dripper and filter set 30 is more environmentally friendly and hygienic. Further, the wire mesh filter 51 that is set in between the inner positioning ring 52 and the outer positioning ring 53 is a single layer design, facilitating cleaning with hot water, avoiding grease generation in the filter element.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A dripper and filter set, comprising a dripper and a filter device, said dripper comprising a top opening, a bottom wall and at least one water outlet cut through said bottom wall, wherein said filter device fits the configuration of said bottom wall and is positioned on said bottom wall within said dripper, comprising a wire mesh filter, an inner positioning ring and an outer positioning ring greater than said inner positioning ring in size, said wire mesh filter comprising a filter surface and a skirt portion extended around said filter surface, said wire mesh filter being attached onto said inner positioning ring with said filter surface supported on a top side of said inner positioning ring to create a filter layer and said skirt portion surrounding the periphery of said inner positioning ring, said outer positioning ring being attached onto said inner positioning ring and said wire mesh filter for enabling said skirt portion to be squeezed in between said inner positioning ring and said outer positioning ring.

2. The dripper and filter set as claimed in claim 1, wherein said inner positioning ring and said outer positioning ring each comprise a plurality of water holes cut through opposing inner perimeter and outer perimeter thereof.

3. The dripper and filter set as claimed in claim 2, wherein the apertures of said water holes are configured subject to a predetermined brewing speed.
